(19) United States
(12) Patent Application Publication
(10) Pub. No.: US 2007/0011603 A1
(43) Pub. Date: Jan. 11, 2007

(54) Method, system, device and software product for showing tooltips for page segments and generating content for the page segments

(76) Inventor: Mikko Makela, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/176,948

(22) Filed: Jul. 6, 2005

(51) Int. Cl. G06F 9/00; G06F 17/00

(52) U.S. Cl. 715/512; 715/711; 715/767; 715/514; 715/738

(57) ABSTRACT

A method, system, device, and software product are presented for describing to a user a section of a page on a small display, such as a mobile phone display. A section selection signal indicates a section of the page, and then a tooltip describes content of that section of the page. The tooltip is superimposed on at least part of the page. Then a larger version of that section of the page can be displayed.

### FIELD OF THE INVENTION

The present invention relates to browsing of documents on a small display.

### BACKGROUND OF THE INVENTION

Portable wireless devices such as mobile phones have become miniaturized during the past decade, and this continuing miniaturization is bounded mainly by the perceptual limits of the human beings who use the devices. Therefore, mobile devices increasingly have comparatively large display areas relative to the rest of the device. The need for small displays presents especially severe problems for hand-held devices that are used for displaying pages from the World Wide Web (WWW), because WWW pages are typically designed for display on desktop screens.

Viewing web pages on a small display normally requires horizontal and vertical scrolling with scroll bars, which is a technique that is generally experienced as uncomfortable or even annoying for users. Consequently, most browsers that are installed in hand-held devices to interpret web page content offer the possibility of viewing web pages in a format that is optimized for the display dimensions of the hand-held device. This is usually achieved by rendering the web page so that it fits the width of the device's display.

Rendering a page so that it fits the width of the device's display causes several problems. For example, rendered pages get very tall, so a lot of vertical scrolling is required. Also, the structure of the web page is often not preserved well by the rendering process, and thus elements such as input fields frequently get separated far away from each other on the display. Moreover, an original layout mode is typically required as an additional viewing method, because some pages do not convert usably into tall and narrow format, and those pages must therefore be viewed the old-fashioned way, with all of the old-fashioned problems.

Consequently, browsing of large web pages on small displays can present difficult problems for the user of a mobile device. Many web-page-viewing solutions developed for small displays initially zoom the web page to fit into the display width, and then divide the page into sections. As these sections may be very small, their content can be difficult for the user to see. One of these methods is described in another application by the present inventor, titled “IMPROVED PRESENTATION OF LARGE PAGES ON SMALL DISPLAYS” (U.S. patent application Ser. No. 10/820,442) which is incorporated herein by reference, for purposes of background. According to that application, the web page is initially zoomed to horizontally fit to the display, and then the web page is divided into small sections from which the user can select the section that he or she wants to view. Unfortunately, when a large page is zoomed to the display width and divided into sections, the display sections get very small, and it can be difficult to see the information they contain, which makes selecting the correct section very difficult. That application furthermore contains information about showing different sections at the same time in the same or different size(s), which is also discussed in the application titled “USER-DEFINED CHANGING OF PAGE REPRESENTATIONS” (PCT/IB2005/001274) hereby incorporated herein by reference for purposes of background.

Another area where similar problems occur is the use of a miniature view for navigation help; the page may be shown in a large presentation on the screen, and then—either automatically or upon user's request—a smaller size presentation of the web page can be shown. The small size representation can be shown either separately from the large representation, or fully/partially on top of the large representation, or instead of the large representation. The user can then move focus to a certain part of the page in this small size representation, and the large size representation scrolls accordingly. One example of this kind of web page viewing method is described in the document titled “SYSTEM AND METHOD FOR VIEWING DIGITAL VISUAL CONTENT ON A DEVICE” (U.S. patent application Ser. No. 11/007,028) which is incorporated herein by reference for purposes of background.

### SUMMARY OF THE INVENTION

The present invention involves automatically generating “tooltips,” which summarize the content of a web page section, in a floating window on top of the original content. The text for a tooltip can be taken from the contents of each web page section. The types of section content summarized by a tooltip may include header elements, large or bolded text, form labels, and/or initial text. Additionally, tooltips containing keywords from a focused section can be shown. The browser can also generate text for tooltips from the source code of the document, or from linked external objects of the document.

Tooltips can be shown immediately, or after the cursor or focus has stayed on a section for a while. Tooltips can also be hidden after having been shown temporarily. If the user has executed a keyword search on a page, then tooltips can show the number of hits inside a focused section, and/or tooltips can show some text around found keywords (a bit like GOOGLE generates text on its search results page).

Tooltips may only contain plain text, or they can also show content formatted as it is on a page, and tooltips could even contain graphics to give the user an even better view of key content in a section of a web page or other document.

Content generated for tooltips could also be used for giving audio feedback to the user; the device could for instance read aloud the text generated for a tooltip, when focus has stayed on a section for a while.

The method, system, device, and software product of the present invention are thus for describing to a user a section of a page on a small display, such as a mobile phone display that displays a web page. A section selection signal indicates a section of the page, and then a tooltip describes content of that section of the page. The tooltip is superimposed on at least part of the page, and then a larger version of that section of the page can be displayed.

Regarding the use of a miniature view for navigation help, it may be difficult to accurately see things from the small size representation, and therefore tooltips can be shown according to the section on top of which the cursor is shown. In this navigation method, the cursor does not necessarily move from section to section but may be “freely” movable to any part of the page, and the cursor usually is a rectangle indicating the part of the page shown in large scale representation, the cursor may be on top of multiple sections, in which case tooltips may be shown for all covered sections, or for instance for section located in the center point of the cursor or for the section which occupies the largest part of the cursor rectangle.

### BRIEF DESCRIPTION OF THE DRAWINGS

FIG. 1 shows a display displaying a web page divided into several sections, according to the prior art, and also displaying only one of those sections.

FIG. 2 is a flow chart according to an embodiment of the present invention.

FIG. 3 is a block diagram of a mobile device according to an embodiment of the present invention.

FIG. 4 is a block diagram of a system according to the present invention.

### DETAILED DESCRIPTION OF THE INVENTION

According to an illustrative embodiment of the present invention, the text for a section's tooltip is taken from that section's contents, and this process of creating the tooltip from the section's contents can advantageously be prioritized as follows.

1) Header elements of a section;

2) Biggest text lines or words (such as font size and bolding) raise priority;

3) For a section that contains a form, the field labels get high priority;

4) First text of a section gets higher priority than later text.

In case there is too much high-priority information to fit in the space allotted for a tooltip, only the highest priority items would be included.

Another high priority item for creating tooltips are alt-texts of images and objects. Alt-text stands for “alternative text,” and this alt-text is typically placed in the code for an image in an HTML page, as an alternative to viewing the actual image. It appears before the image is fully loaded, or if a web page visitor has their graphics turned off, or if the web page visitor positions the mouse on the image.

Text for tooltips can also be taken from external objects, like keywords from a Macromedia Flash object. Tooltip text could furthermore vary depending upon the status of content; for instance if a section only contains a Macromedia Flash object that is currently being downloaded, texts from its “standby” attribute could be shown in the section's tooltip until the object has been loaded.

If a section mostly contains links (for instance if over 50% of its content is links, and there are more that 10 links), then the beginning of a tooltip can include the word text “Links” (or an image representing links) followed by texts of the links, separated by commas.

If an item for a tooltip would require more than one line, it can be truncated to fit to one line. A tooltip's text can also be defined by the page author, for example with some particular attribute or identifier. Tooltip texts can be generated in the client (e.g. the user device), but they could additionally or alternatively be generated by a content optimization server in the network.

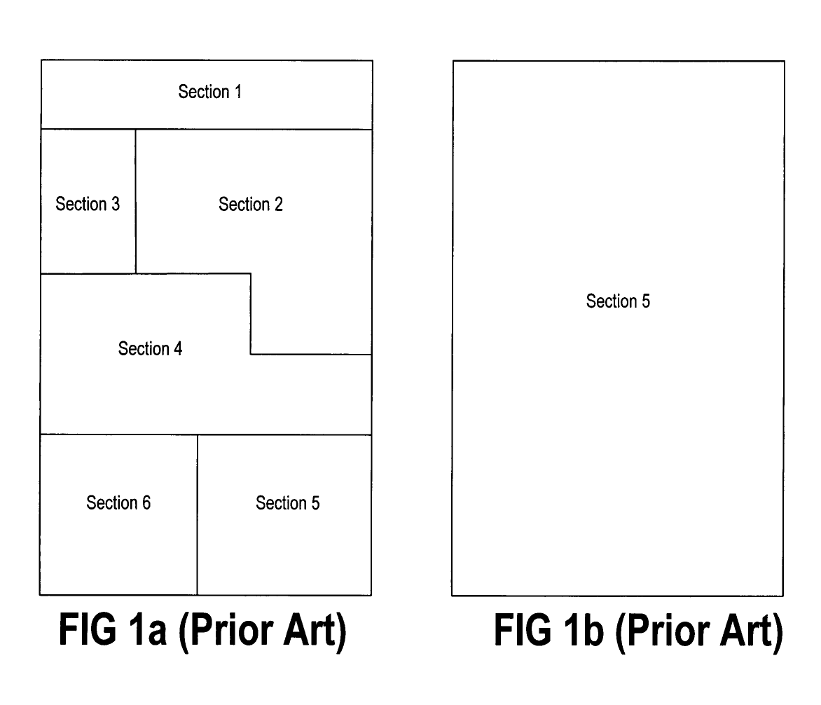

Referring now to FIG. 1, a small display is shown. FIG. 1a depicts a displayed web page divided up into sections. Once the user selects a section, for example section 5, then that section can be enlarged as shown in FIG. 1b. The reader will be able to clearly see the section in FIG. 1b, but will typically not be able to see so clearly the contents of the much smaller sections in FIG. 1a. That is why a tooltip is needed for each section.

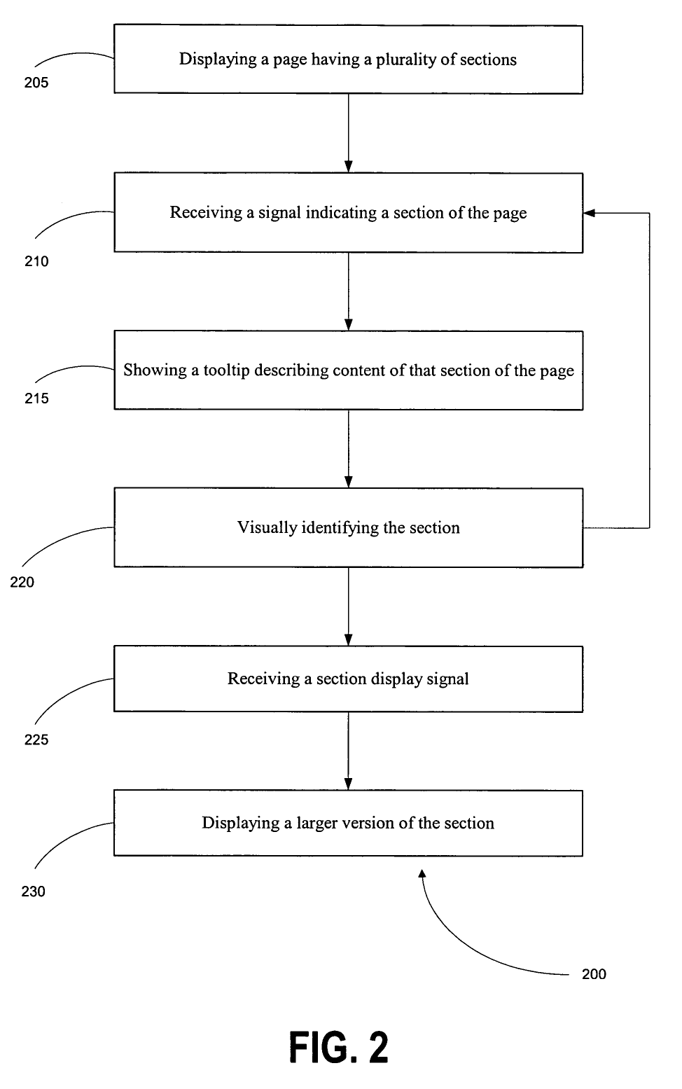

Turning now to FIG. 2, this is a flow chart showing a method 200 according to an embodiment of the present invention, for describing to a user a section of a page on a display. First, a page is displayed 205 having a plurality of sections. Then, a section selection signal is received 210 that indicates a section of the page. For example, the user will place his or her cursor over the section that the user wants to know more about, and that will select a section for which a tooltip will then be shown 215. The tooltip describes the content of that section of the page. In addition to the tooltip, it can also be helpful to very clearly identify 220 the section that the tooltip describes, and that can be done by (for example) surrounding that section with a special (e.g. red) border. This part of the process can be repeated, so that the user is able to see tooltips for several different section of the page. Each tooltip will be superimposed on at least part of the page, for example in a floating window that at least partly covers the section which the tooltip describes.

Once the user has found a section having a tooltip description of interest, the user will then indicate that interest and the mobile device will thus receive 225 a section display signal. Consequently, a larger version of that section will be displayed 230. The larger version of that section may be displayed alone, or together with other sections. The other sections may all be shown as smaller versions, all be shown as larger versions, or in any other combination (for instance 2 sections as smaller versions, 3 as medium size versions and 2 as larger versions) Each section of the page may have a tooltip (“may have”, because there can for instance be empty sections for which a tooltip may be empty), and substantially every point of the web page is part of a corresponding section.

Pointing to the section of interest with the cursor is not the only way for the user to indicate interest in a section and so triggering a tooltip. For instance, a tooltip may also be shown for a section(s) that is shown in a certain position (e.g. in the center) on the display or the like.

A tooltip may comprise simply a textual summary of the section, containing prioritized information about the section, including header elements in the section, larger or bolded text in the section, labels of a form in the section, initial text in the section, and/or keywords in the section. If the page is searched for a search term, then each tooltip can also contain search hit information. It is possible for only one tooltip to be shown at a time, although it is also possible to show more than one, such as by showing the tooltip for a section of interest as well as the tooltips for the immediately adjacent sections.

It is also possible to automatically show tooltips for the most relevant section(s), for instance after loading the page or after the user has requested it. Relevancy of a section may simply be determined by content of a section; for instance, the amount of text in a section may be used to determine the relevancy. Or there can be a system that can track and store information about the user's behavior on different pages; then relevancy may be determined for instance by which section(s) on that page the user has viewed most often during the previous visits to that page/site. The tooltip may also indicate to the user whether the section of interest has significantly changed after the last visit to that page. Or, content of sections may be automatically checked during loading of the page, and tooltips can be automatically shown for section(s) that have significantly changed since the last visit. In addition/alternatively to indicating changes with tooltips, changed section(s) can also be shown with some other indication that indicates that they have been changed, for instance they can be shown with a bit different coloring than other section(s) or with some additional icon, as discussed in the related invention report “USER-DEFINED CHANGING OF PAGE REPRESENTATIONS” (already mentioned above) which contains more information about tracking/storing user's behavior on pages.

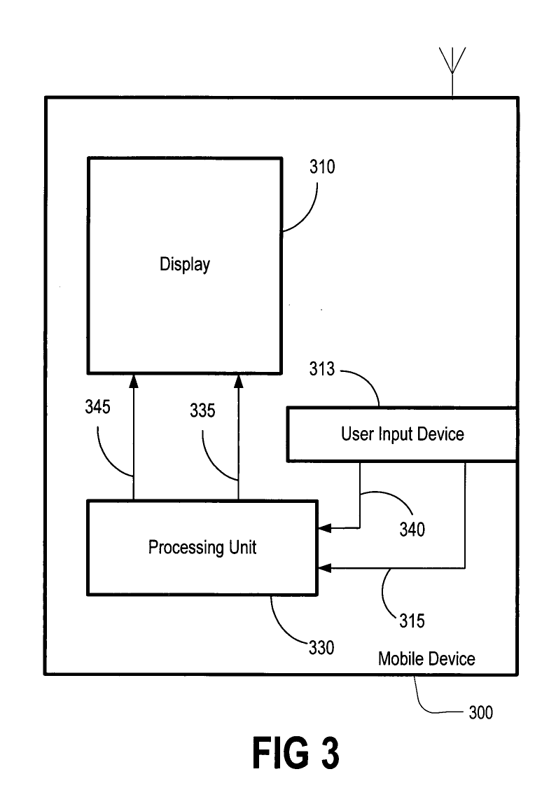

Turning now to FIG. 3, this shows a mobile device 300 according to an embodiment of the present invention. This mobile device is for describing to a user a section of a page. The mobile device includes a display 310 for displaying the page. A user input device 313 provides a section selection signal 315 indicative of which section of the page the user wants to find out about. A processing unit 330 is responsive to the section selection signal 315, and is for providing a tooltip signal 335 that is indicative of content of the section that the user wanted to find out about. The display is responsive to the tooltip signal 335, and is for displaying the tooltip superimposed on at least part of the page.

According to this embodiment of the mobile device, the user input device 313 is also for providing a section display signal 340, when the user decides which section he or she wants to enlarge. The processing unit 330 is then responsive to the section display signal 340, and provides a zoom signal 345. The display 310 is responsive to the zoom signal 345, and is for displaying a larger version of the section of the page.

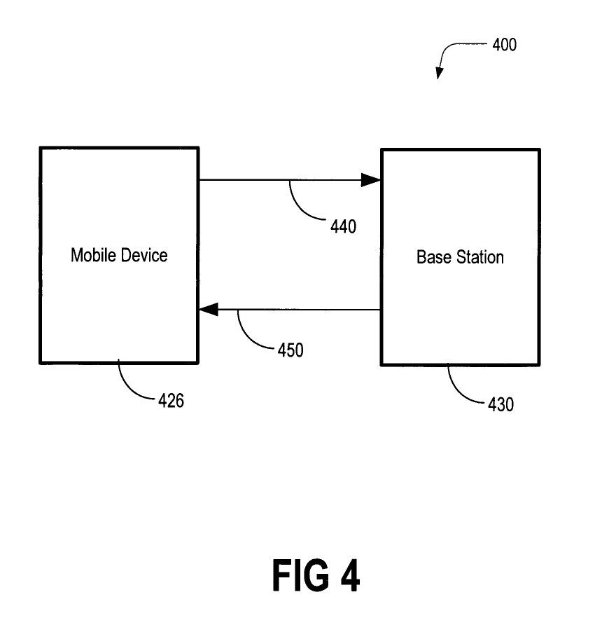

Turning now to FIG. 4, this shows a system 400 for describing to a mobile device user a section of a page on his or her display. The system includes a mobile device 426 and a base station 430. The mobile device provides a section selection signal 440 indicative of the section of the page that the user wants to find out about. The base station 430 responds to the section selection signal 440 by providing a tooltip signal 450 indicative of content of the section of the page. Of course, the mobile device has a display that shows the tooltip superimposed on at least part of the page.

The present invention is adaptable to other document types beyond web pages, and thus it is likely that tooltips can enhance viewing of MICROSOFT POWER POINT and ADOBE PDF documents. It is also to be understood that all of the present figures, and the accompanying narrative discussions of best mode embodiments, do not purport to be completely rigorous treatments of the method, system, network element, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

It should also be noted that the present invention could be applied to 3D, if for instance a 3D Virtual Reality Modeling Language (VRML) document can be divided into cubes, and when the user moves focus onto a cube then a tooltip shows the contents of that cube. The tooltip itself may also be in 3D, and can be in any location (in front, behind, in the middle) with respect to an object/document. Therefore, everything mentioned in this patent application can apply to 3D also.

What is claimed is:

1. A method for describing to a user a section of a page on a display, comprising:
receiving a section selection signal indicative of the section of the page; and
showing a tooltip describing content of the section of the page, in response to the section selection signal,
wherein the tooltip is superimposed on at least part of the page.

2. The method of claim 1, followed by:
receiving a section display signal; and
displaying a larger version of the section of the page, in response to the section display signal.

3. The method of claim 1,
wherein the section of the page is one of a plurality of sections respectively having a plurality of tooltips, and
wherein substantially any point in the page corresponds to one and only one of the tooltips.

4. The method of claim 1, further comprising:
visually identifying the section having the content that is described by the tooltip.

5. The method of claim 4, wherein the identifying step is performed by enclosing the section within a special border.

6. The method of claim 2, wherein the displaying step excludes all other sections of the page from being displayed.

7. The method of claim 1, wherein the tooltip comprises a textual summary of the section, and
wherein the textual summary contains prioritized information about the section.

8. The method of claim 7, wherein the prioritized information is about at least one of the following:
header elements in the section;
larger or bolded text in the section;
labels of a form in the section;
initial text in the section; and
keywords in the section.

9. The method of claim 1, further comprising:
searching the page for a search term; and
including search hit information in the tooltip.

10. The method of claim 1, wherein only one tooltip is shown at a time, and wherein the page is a web page.

11. An electronic device for describing to a user a section of a page, comprising:
a display for displaying the page;
a user input device, for providing a section selection signal indicative of the section of the page;
a processing unit, responsive to the section selection signal, for providing a tooltip signal indicative of content of the section of the page,
wherein the display is responsive to the tooltip signal, and is for displaying the tooltip superimposed on at least part of the page.

12. The electronic device of claim 11,
wherein the user input device is also for providing a section display signal,
wherein the processing unit is also responsive to the section display signal, and is also for providing a zoom signal, and
wherein the display is responsive to the zoom signal, and is for displaying a larger version of the section of the page.

13. The electronic device of claim 11,
wherein the section of the page is one of a plurality of sections respectively having a plurality of tooltips, and
wherein substantially any point in the page corresponds to one and only one of the tooltips.

14. The electronic device of claim 11,
wherein the display is also for visually identifying the section having the content that is described by the tooltip.

15. The electronic device of claim 14, wherein the display is for visually identifying the section by enclosing the section within a special border.

16. The electronic device of claim 12, wherein the larger version of the section of the page excludes all other sections of the page from being displayed.

17. The electronic device of claim 11, wherein the tooltip comprises a textual summary of the section, and
wherein the textual summary contains prioritized information about the section.

18. The electronic device of claim 17, wherein the prioritized information is about at least one of the following:
header elements in the section;
larger or bolded text in the section;
labels of a form in the section;
initial text in the section; and
keywords in the section.

19. The electronic device of claim 11, wherein the tooltip includes search hit information if the page has been searched for a search term.

20. The electronic device of claim 11, wherein only one tooltip is shown at a time, and wherein the page is a web page.

21. A software product for describing to a user a section of a page on a display, the software product comprising a computer readable medium having executable codes embedded therein; the codes, when executed, being adapted to carry out the steps of:
receiving a section selection signal indicative of the section of the page; and
showing a tooltip describing content of the section of the page, in response to the section selection signal,
wherein the tooltip is superimposed on at least part of the page.

22. The software product of claim 21,
wherein the tooltip comprises a textual summary of the section, and
wherein the textual summary contains prioritized information about the section.

23. A system for describing a section of a page on a display, comprising:
a mobile device having the display, for providing a section selection signal indicative of the section of the page; and
a base station, responsive to the section selection signal, for providing a tooltip signal indicative of content of the section of the page,
wherein the display is responsive to the tooltip signal, and is for displaying the tooltip superimposed on at least part of the page.

24. The system of claim 23,
wherein the tooltip comprises a textual summary of the section, and
wherein the textual summary contains prioritized information about the section.

25. A network element for describing a section of a page, comprising:
a transceiver, for receiving a section selection signal indicative of the section of the page; and
a processing unit, responsive to the section selection signal, for providing a tooltip signal indicative of content of the section of the page,
wherein the transceiver is also for transmitting the tooltip signal.

26. The network element of claim 25,
wherein the tooltip signal comprises a textual summary of the section, and
wherein the textual summary contains prioritized information about the section.
